(19) United States
(12) Patent Application Publication
(10) Pub. No.: US 2025/0300343 A1
(43) Pub. Date: Sep. 25, 2025

(54) RECONFIGURABLE ANTENNAS FOR EYEWEAR

(71) Applicant: QUALCOMM Incorporated, San Diego, CA (US)

(72) Inventors: Cheng-Fan WEI, New Taipei City (TW); Chao-Kuei CHANG, Taipei City (TW); Yi-Hsiang KUNG, Taipei City (TW)

(21) Appl. No.: 18/611,208

(22) Filed: Mar. 20, 2024

(51) Int. Cl. H01Q 1/27; G02C 11/00; H01Q 1/22; H01Q 21/30; H04B 1/3827

(52) U.S. Cl. CPC H01Q 1/273; H01Q 1/22; H01Q 21/30; H04B 1/385; G02C 11/10; H04B 2001/3866

(57) ABSTRACT

Certain aspects of the present disclosure provide eyewear having a multi-mode antenna structure. Example eyewear comprises a frame comprising a multi-mode antenna structure comprising antenna traces comprising a first antenna trace and a second antenna trace, a set of switches comprising a first switch and a second switch, wherein each switch of the switches is coupled to at least one of the antenna traces, and wherein the switches is configured to selectively switch among switching states, each of the switching states being associated with a corresponding antenna configuration of a plurality of antenna configurations formed by the antenna traces; a first antenna feed selectively coupled to the first antenna trace via the first switch; and a second antenna feed selectively coupled to the second antenna trace via the second switch. The frame further comprises one or more temple arms coupled to the frame.

### INTRODUCTION

### Field of the Disclosure

Aspects of the present disclosure relate to wireless communications, and more particularly, to an antenna structure for eyewear.

### DESCRIPTION OF RELATED ART

Wireless communication systems are widely deployed to provide various telecommunication services such as telephony, video, data, messaging, broadcasts, etc. These wireless communications systems may employ multiple-access technologies capable of supporting communications with multiple users by sharing available wireless communications system resources with those users.

Modern wireless communication devices (such as cellular telephones) are generally mandated to meet radio frequency (RF) exposure limits set by certain governments and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmit power of the wireless communication device accordingly to comply with the RF exposure limit.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, such as eyewear capable of wireless communications.

### SUMMARY

Some aspects provide eyewear configured for wireless communications. The eyewear comprise a frame comprising a multi-mode antenna structure. The multi-mode antenna structure comprises a plurality of antenna traces comprising a first antenna trace and a second antenna trace, a set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces; a first antenna feed selectively coupled to the first antenna trace via the first switch; and a second antenna feed selectively coupled to the second antenna trace via the second switch. The frame further comprises one or more temple arms coupled to the frame.

Some aspects provide a method of wireless communications by eyewear. The method includes forming a first antenna configuration from a plurality of antenna traces and a set of switches, the plurality of antenna traces comprising a first antenna trace and a second antenna trace, the set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces. The method further includes communicating via one or more antennas associated with the first antenna configuration.

Other aspects provide: an apparatus operable, configured, or otherwise adapted to perform any one or more of the aforementioned methods and/or those described elsewhere herein; a non-transitory, computer-readable medium comprising instructions that, when executed by a processor of an apparatus, cause the apparatus to perform the aforementioned methods as well as those described elsewhere herein; a computer program product embodied on a computer-readable storage medium comprising code for performing the aforementioned methods as well as those described elsewhere herein; and/or an apparatus comprising means for performing the aforementioned methods as well as those described elsewhere herein. By way of example, an apparatus may comprise a processing system, a device with a processing system, or processing systems cooperating over one or more networks.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain typical aspects of this disclosure and are therefore not to be considered limiting of its scope, for the description may admit to other equally effective aspects.

FIG. 1 illustrates an example wireless communication system exhibiting radio frequency (RF) exposure to a human.

FIG. 2 illustrates a design of an example wireless communication device communicating with another device.

FIG. 3 depicts examples of transmit powers over time in compliance with an RF exposure specification.

FIGS. 4A and 4B illustrate an example of eyewear having a multi-mode antenna structure.

FIG. 4C illustrates an example antenna tuner.

FIGS. 5A-E illustrate example antenna configurations.

FIGS. 6A and 6B illustrate example RF exposure scenarios.

FIG. 7 illustrates an example architecture for communicating via eyewear with a multi-mode antenna structure.

FIG. 8 illustrates example operations for wireless communication by a wireless device.

FIG. 9 illustrates a communications device that may include various components configured to perform operations for the techniques disclosed herein.

To facilitate understanding, identical reference numerals have been used, where possible, to designate identical elements that are common to the figures. It is contemplated that elements disclosed in one aspect may be beneficially utilized in other aspects without specific recitation.

### DETAILED DESCRIPTION

Aspects of the present disclosure provide apparatuses, methods, processing systems, and computer-readable mediums for reconfigurable antennas for electronic eyewear.

Electronic eyewear may be used for various applications. For example, certain electronic eyewear may be used for viewing augmented reality (AR), virtual reality (VR), and/or mixed reality (MR) content. Some electronic eyewear may serve as a wearable display, for example, for a computer, smartphone, tablet, or laptop. As smart glasses, electronic eyewear may be a wearable computing device to perform various tasks. For example, the electronic eyewear may serve as a wearable hands-free camera for capturing photos or videos from the user's point of view. In certain cases, the electronic eyewear may serve as a hands-free audio source and/or microphone, for example, to make calls, interact with a conversational virtual assistant, dictate text (e.g., text messages, emails, etc.), and/or listen to audio (e.g., music, podcasts, or audiobooks).

Some electronic eyewear are capable of wireless communications, for example, wireless local area network (WLAN) communications, wireless wide area network (WWAN) communications, and/or short range communications (e.g., Bluetooth). As an example, the electronic eyewear may wirelessly connect to the internet, a data network, or another device (e.g., a computer, smartphone, tablet, or laptop) to access audio and/or visual content. In some cases, the electronic eyewear may upload images and/or stream video captured from the eyewear via wireless communications. In certain cases, the electronic eyewear may wirelessly connect to the virtual assistant or an audio streaming service. To enable such wireless communications, the electronic eyewear may include a radio having one or more antennas and radio frequency (RF) circuitry (e.g., an RF front-end transceiver).

Certain governmental agencies and/or standards bodies (e.g., the Federal Communications Commission (FCC) for the United States; the Innovation, Science and Economic Development Canada (ISED) for Canada; or the International Commission on Non-Ionizing Radiation Protection (ICNIRP) guidelines followed by the European Union (EU)) define specifications for human exposure to RF electromagnetic fields emitted from electronic devices (e.g., cellular phones, smart phones, wearable devices, etc.). For example, an RF exposure specification may define the maximum permissible exposure (MPE) limit for field strength and power density for transmitters operating at frequencies of 300 kHz to 100 GHz, as further described herein.

Technical problems for electronic eyewear include, for example, employing a design that mimics eyeglasses, satisfying RF exposure specifications, and allowing for flexible wireless communications. As electronic eyewear is a human wearable device, there is an expectation among users for electronic eyewear to mimic eyeglasses, for example, in size, style, comfort, weight, etc. Thus, there is a continuous desire for the electrical circuitry to facilitate the industrial design expectations for electronic eyewear. More specifically, the radio is expected to allow the electronic eyewear to meet the industrial design expectations among users.

In some cases, the antenna of electronic eyewear is arranged on a temple arm portion of the eyewear, and in particular on a single side of the user's head. Thus, depending on the position of the user's head, the electronic eyewear may be relying on a non-line of sight (NLOS) communications path to communicate with another device. Therefore, an antenna arranged on the temple arm may encounter reduced signal quality and/or signal strength in such NLOS scenarios. In some cases, an antenna arranged on the temple arm may be constrained in size (relative to the wavelength of the frequency bands used for wireless communications) due to the industrial design expectations for electronic eyewear. For example, certain antennas are resonant at a half wavelength or a quarter wavelength of the frequency bands used for wireless communications. An antenna arranged on the temple arm may not have the electrical length to be resonant at the frequency bands used for wireless communications. Thus, the antenna may encounter reduced radiation efficiency compared to antennas that can be designed to resonate at the frequency bands used for wireless communications. Moreover, such an antenna arrangement exposes the user's head to RF emissions, which leads to inevitably high RF exposure, and in some cases, in the same location due to the antenna being arranged on a single side of the user's head.

In certain cases, the antenna of electronic eyewear is arranged on the frame of the eyewear. Some antennas designs feature one or two antennas arranged on the frame of the eyewear. In some cases, a single antenna is arranged along the brow and bridge portion of the frame. In certain cases, an antenna is arranged around each rim of the frame, and thus, the frame has two antennas. In each of these cases, the antennas have been fixed in structure, resulting in limited antenna radiation modes and/or operating frequencies. Here too, the fixed antenna structures may affect the RF exposure. As the antenna structure exposes the user's head to RF energy in either the same location or two locations, the antenna structure may provide few or no options for changing the locations of RF exposure.

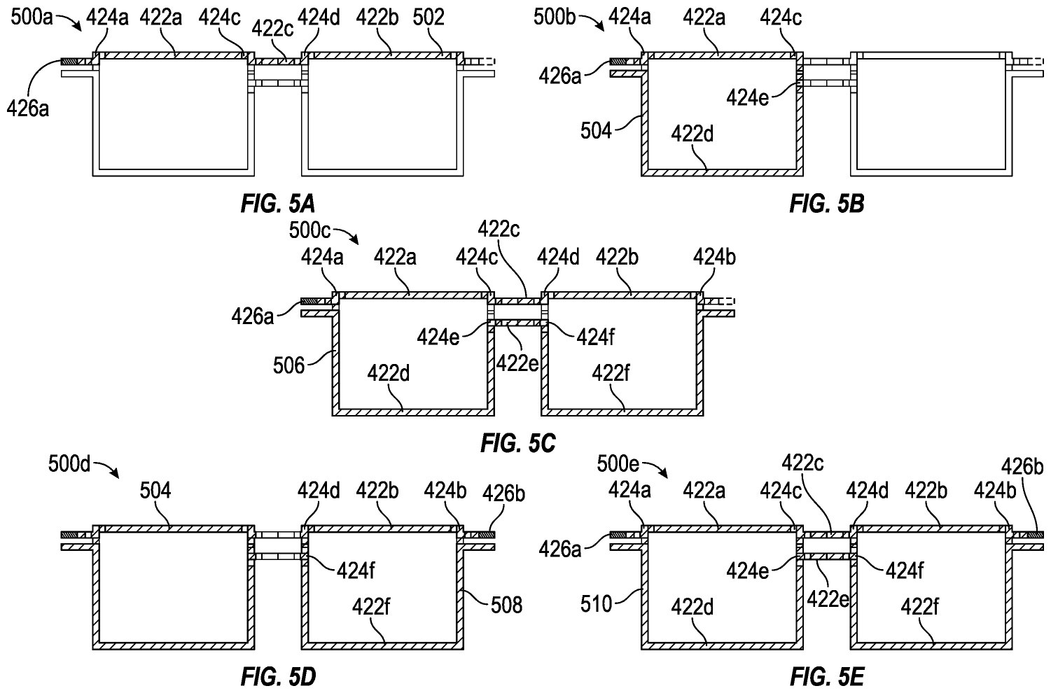

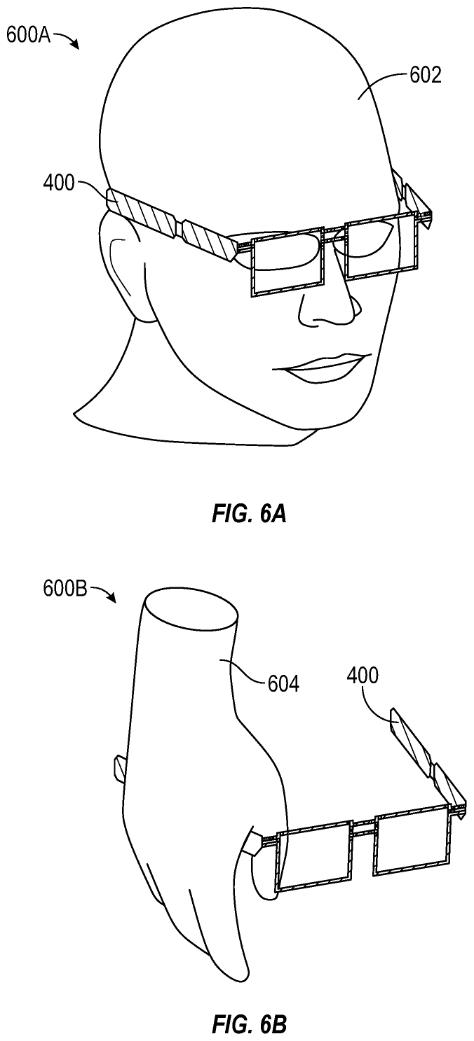

Aspects described herein overcome the aforementioned technical problem(s) by providing eyewear having a multi-mode antenna structure that is configurable into one or more antennas for different communication modes, frequency bands, and/or RF exposure scenarios. The antenna structure may employ a network of switches and antenna traces to selectively form an antenna from at least one of the antenna traces for wireless communications. In certain aspects, the switches may have various switching states that interconnect antenna traces to form various antenna configurations along the rims of the eyewear, as further described herein with respect to FIGS. 5A-6B. For example, a first antenna configuration may form an antenna from antenna traces arranged along the rims of the eyewear, whereas a second antenna configuration may form another antenna from antenna traces arranged along one of the rims of the eyewear. In certain aspects, the eyewear may further employ an antenna tuner that matches the impedance of the radio to the impedance of the antenna, as further described herein.

The eyewear having a multi-mode antenna structure described herein may provide various beneficial effects and/or advantages. The multi-mode antenna structure may enable improved wireless communication performance, such as improved antenna efficiencies, increased signal strengths, and/or improved signal qualities. The improved wireless communication performance may be attributable to the various antenna configurations that can be selected for a given communications scenario. As an example, the antenna configurations may allow an antenna to be formed with an electrical length that enables the antenna to operate at higher efficiencies, such as efficiencies of 90% or more, and the antenna tuner may further enhance or enable higher antenna efficiencies.

In some cases, the multi-mode antenna structure may operate in a single input single output (SISO) wireless communication mode, for example, to apply full power to a transmission and increase the signal strength. In certain cases, the multi-mode antenna structure may operate in a multiple input multiple output (MIMO) wireless communication mode to increase throughput and increase the signal quality of communications.

In some cases, the multi-mode antenna structure may allow the eyewear to adapt to the present RF exposure conditions. For example, the reconfigurable antenna structure may allow the eyewear to vary where RF energy is being emitted from the eyewear to distribute the RF exposure across the head of the user (e.g., in a brow region, left eye, right eye, both eyes, etc.). In certain cases, the reconfigurable antenna structure may allow the eyewear to select a combination of an antenna configuration, operating frequency, and antenna feed location to adjust the level of RF exposure and/or location of RF exposure, as further described herein.

### Example Wireless Communications

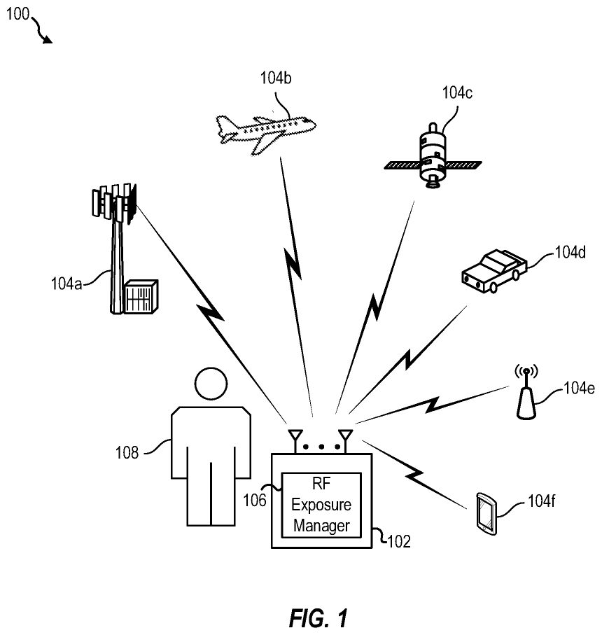

FIG. 1 illustrates an example wireless communication system 100 in which aspects of the present disclosure may be performed. For example, the wireless communication system 100 may include a wireless wide area network (WWAN) and/or a wireless local area network (WLAN). For example, a WWAN may include a New Radio (NR) system (e.g., a Fifth Generation (5G) NR network), an Evolved Universal Terrestrial Radio Access (E-UTRA) system (e.g., a Fourth Generation (4G) network), a Universal Mobile Telecommunications System (UMTS) (e.g., a Second Generation (2G) or Third Generation (3G) network), a code division multiple access (CDMA) system (e.g., a 2G/3G network), any future WWAN system, or any combination thereof. A WLAN may include a wireless network configured for communications according to an Institute of Electrical and Electronics Engineers (IEEE) standard such as one or more of the 802.11 standards, etc. In some cases, the wireless communication system 100 may include a device-to-device (D2D) communications network or a short-range communications system, such as Bluetooth communications.

As illustrated in FIG. 1, the wireless communication system 100 may include a first wireless device 102 communicating with any of various second wireless devices 104a-f (a second wireless device 104) via any of various radio access technologies (RATs), where a wireless device may refer to a wireless communication device. The RATs may include, for example, WWAN communications (e.g., E-UTRA and/or 5G NR), WLAN communications (e.g., IEEE 802.11), vehicle-to-everything (V2X) communications, non-terrestrial network (NTN) communications, short-range communications (e.g., Bluetooth), etc.

The first wireless device 102 may be emitting RF signals in proximity to a human 108, who may be the user of the first wireless device 102 and/or a bystander. As an example, the first wireless device 102 may be held in the hand of the human 108 and/or positioned against or near the head of the human 108. In certain cases, the first wireless device 102 may be positioned in a pocket or bag of the human 108. In some cases, the first wireless device 102 may be positioned proximate to the human 108 as a mobile hotspot. To ensure the human 108 is not overexposed to RF emissions from the first wireless device 102, the first wireless device 102 may control the transmit power associated with the RF signals in accordance with an RF exposure limit, as further described herein, where the RF exposure limit may depend on a corresponding exposure scenario (such as, head exposure, extremity (e.g., hand) exposure, body (body-worn) exposure, hotspot exposure, etc.). Extremities may include, for example, hands, wrists, feet, ankles, and pinnae.

The first wireless device 102 may include any of various wireless communication devices including a user equipment (UE), a wireless station, an access point, a customer-premises equipment (CPE), etc. In certain aspects, the first wireless device 102 includes an RF exposure manager 106 that determines an antenna configuration for eyewear based at least in part on an RF exposure scenario and/or an RF exposure report, in accordance with aspects of the present disclosure.

The second wireless devices 104a-f may include, for example, a base station 104a, an aircraft 104b, a satellite 104c, a vehicle 104d, an access point (AP) 104e, and/or a UE 104f. Further, the wireless communication system 100 may include terrestrial aspects, such as ground-based network entities (e.g., the base station 104a and/or access point 104e), and/or non-terrestrial aspects, such as the aircraft 104b and the satellite 104c, which may include network entities on-board (e.g., one or more base stations) capable of communicating with other network elements (e.g., terrestrial base stations) and/or user equipment.

The base station 104a may generally include: a NodeB, enhanced NodeB (eNB), next generation enhanced NodeB (ng-eNB), next generation NodeB (gNB or gNodeB), access point, base transceiver station, radio base station, radio transceiver, transceiver function, transmission reception point, and/or others. The base station 104a may provide communications coverage for a respective geographic coverage area, which may sometimes be referred to as a cell, and which may overlap in some cases (e.g., a small cell may have a coverage area that overlaps the coverage area of a macro cell). A base station may, for example, provide communications coverage for a macro cell (covering relatively large geographic area), a pico cell (covering relatively smaller geographic area, such as a sports stadium), a femto cell (relatively smaller geographic area (e.g., a home)), and/or other types of cells.

The first wireless device 102 and/or the UE 104f may generally include: a cellular phone, smart phone, session initiation protocol (SIP) phone, laptop, personal digital assistant (PDA), satellite radio, global positioning system, multimedia device, video device, digital audio player, camera, game console, tablet, smart device, wearable device, vehicle, electric meter, gas pump, large or small kitchen appliance, healthcare device, implant, sensor/actuator, display, internet of things (IoT) devices, always on (AON) devices, edge processing devices, or other similar devices. A UE may also be referred to more generally as a mobile device, a wireless device, a wireless communications device, a wireless station (STA), a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and other terms.

In certain cases, the first wireless device 102 may control the transmit power used to emit RF signals in compliance with an RF exposure limit. RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In some cases, the RF exposure may be expressed in terms of a specific energy absorption (SA) limit or an absorbed energy density (Uab) limit, for example, for a total RF energy limit allowed in a specific time period. In certain cases, a maximum permissible exposure (MPE) limit in terms of PD may be imposed for wireless communication devices using transmission frequencies above 6 GHz. Frequency bands of 24 GHz to 71 GHz or greater are sometimes referred to as a “millimeter wave” (“mmW” or “mm Wave”). The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change. Certain RF exposure limits may be specified based on a maximum RF exposure metric (e.g., SAR or PD) averaged over a specified time window (e.g., 100 or 360 seconds for sub-6 GHz frequency bands or 2 seconds for 60 GHz bands).

SAR may be used to assess RF exposure for transmission frequencies less than 6 GHz, which cover wireless communication technologies such as 2G/3G (e.g., CDMA), 4G (e.g., E-UTRA), 5G (e.g., NR in sub-6 GHz bands), IEEE 802.11 (e.g., a/b/g/n/ac), etc. PD may be used to assess RF exposure for transmission frequencies higher than 6 GHz, which cover wireless communication technologies such as IEEE 802.11ad, 802.11ay, 5G in mmWave bands, etc. Thus, different metrics may be used to assess RF exposure for different wireless communication technologies.

A wireless device (e.g., the first wireless device 102) may be capable of transmitting signals using multiple wireless communication technologies and/or frequency bands, and in some cases, capable of simultaneous transmission of such signals. For example, the wireless device may transmit signals using a first wireless communication technology operating at or below 6 GHz (e.g., 3G, 4G, 5G, 802.11a/b/g/n/ac, etc.) and a second wireless communication technology operating above 6 GHz (e.g., mm Wave 5G in 24 to 60 GHz bands, IEEE 802.11ad or 802.11ay). In certain aspects, the wireless device may transmit signals using the first wireless communication technology (e.g., 3G, 4G, 5G in sub-6 GHz bands, IEEE 802.11ac, etc.) in which RF exposure may be measured in terms of SAR, and the second wireless communication technology (e.g., 5G in 24 to 71 GHz bands, IEEE 802.11ad, 802.11ay, etc.) in which RF exposure may be measured in terms of PD.

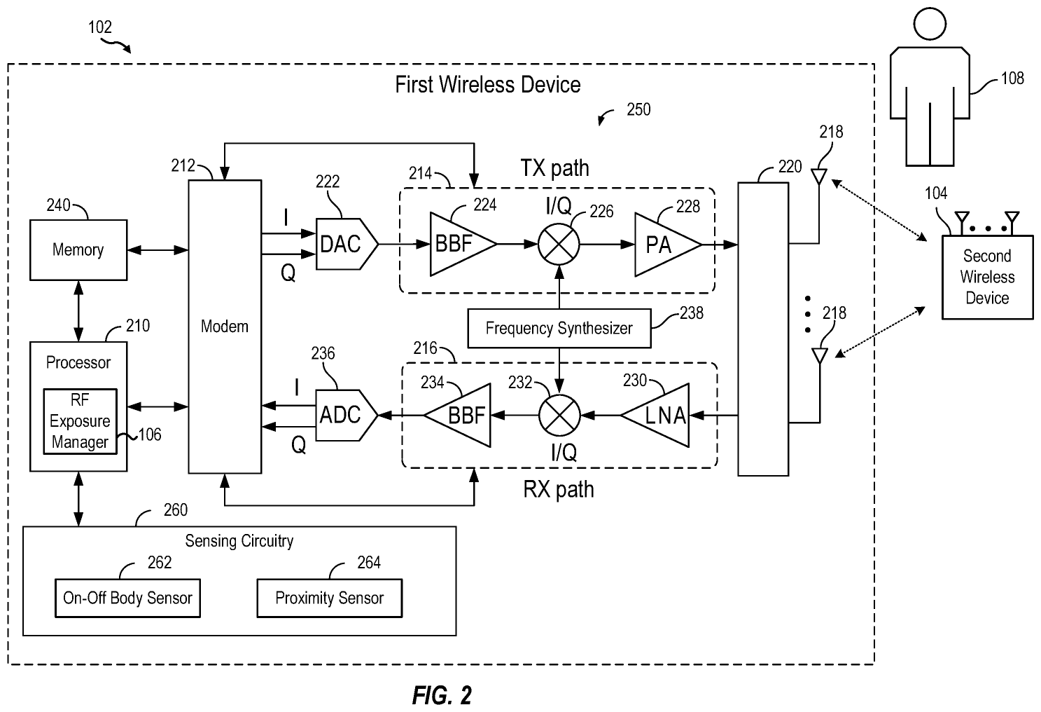

FIG. 2 illustrates example components of the first wireless device 102, which may be used to communicate with any of the second wireless devices 104, in some cases, in proximity to human tissue as represented by the human 108.

The first wireless device 102 may be, or may include, a chip, system on chip (SoC), chipset, package or device that includes one or more modems 212. In some cases, the modem(s) 212 may include, for example, any of a WWAN modem (e.g., a modem configured to communicate via E-UTRA and/or 5G NR standards), a WLAN modem (e.g., a modem configured to communicate via 802.11 standards), a Bluetooth modem, a NTN modem, etc. In certain aspects, the first wireless device 102 also includes one or more radios (collectively “the radio 250”). In some aspects, the first wireless device 102 further includes one or more processors, processing blocks or processing elements (collectively “the processor 210”) and one or more memory blocks or elements (collectively “the memory 240”).

In certain aspects, the processor 210 may include a processor representative of an application processor that generates information (e.g., application data such as content requests) for transmission and/or receives information (e.g., requested content) via the modem 212. In some cases, the processor 210 may include a microprocessor associated with the modem 212, which may implement the RF exposure manager 106 and/or process any of certain protocol stack layers associated with a radio access technology (RAT). For example, the processor 210 may process any of an application layer, packet layer, WLAN protocol stack layers (e.g., a link or a medium access control (MAC) layer), and/or WWAN protocol stack layers (e.g., a radio resource control (RRC) layer, a packet data convergence protocol (PDCP) layer, a radio link control (RLC) layer, and a MAC layer). In some cases, at least one of the modems 212 (e.g., the WWAN modem) may be in communication with one or more of the other modems 212 (e.g., the WLAN modem and/or Bluetooth modem). For example, the processor 210 may be representative of at least one of the modems 212 in communication with one or more of the other modems 212.

The modem 212 may include an application-specific integrated circuit (ASIC), among other possibilities. The modem 212 may generally be configured to implement a physical (PHY) layer. For example, the modem 212 may be configured to modulate packets and to output the modulated packets to the radio 250 for transmission over a wireless medium. The modem 212 is similarly configured to obtain modulated packets received by the radio 250 and to demodulate the packets to provide demodulated packets. In addition to a modulator and a demodulator, the modem 212 may further include digital signal processing (DSP) circuitry, automatic gain control (AGC), a coder, a decoder, a multiplexer and a demultiplexer (not shown).

As an example, while in a transmission mode, the modem 212 may obtain data from the processor 210. The data obtained from the processor 210 may be provided to a coder, which encodes the data to provide encoded bits. The encoded bits may be mapped to points in a modulation constellation (e.g., using a selected modulation and coding scheme) to provide modulated symbols. The modulated symbols may be mapped, for example, to spatial stream(s) or space-time streams. The modulated symbols may be multiplexed, transformed via an inverse fast Fourier transform (IFFT) block, and subsequently provided to DSP circuitry for transmit windowing and filtering. The digital signals may be provided to a digital-to-analog converter (DAC) 222. In certain aspects involving beamforming, the modulated symbols in the respective spatial streams may be precoded via a steering matrix prior to provision to the IFFT block.

The modem 212 may be coupled to the radio 250 including a transmit (TX) path 214 (also known as a transmit chain) for transmitting signals via one or more antennas 218 and a receive (RX) path 216 (also known as a receive chain) for receiving signals via the antennas 218. When the TX path 214 and the RX path 216 share an antenna 218, the paths may be connected with the antenna via an interface 220, which may include any of various suitable RF devices, such as a switch, a duplexer, a diplexer, a multiplexer, and the like. As an example, the modem 212 may output digital in-phase (I) and/or quadrature (Q) baseband signals representative of the respective symbols to the DAC 222.

Receiving I or Q baseband analog signals from the DAC 222, the TX path 214 may include a baseband filter (BBF) 224, a mixer 226 (which may include one or several mixers), and a power amplifier (PA) 228. The BBF 224 filters the baseband signals received from the DAC 222, and the mixer 226 mixes the filtered baseband signals with a transmit local oscillator (LO) signal to convert the baseband signal to a different frequency (e.g., upconvert from baseband to a radio frequency). In some aspects, the frequency conversion process produces the sum and difference frequencies between the LO frequency and the frequencies of the baseband signal. The sum and difference frequencies are referred to as the beat frequencies. Some beat frequencies are in the RF range, such that the signals output by the mixer 226 are typically RF signals, which may be amplified by the PA 228 before transmission by the antenna 218. The antennas 218 may emit RF signals, which may be received at the second wireless device 104. While one mixer 226 is illustrated, several mixers may be used to upconvert the filtered baseband signals to one or more intermediate frequencies and to thereafter upconvert the intermediate frequency signals to a frequency for transmission.

The RX path 216 may include a low noise amplifier (LNA) 230, a mixer 232 (which may include one or several mixers), and a baseband filter (BBF) 234. RF signals received via the antenna 218 (e.g., from the second wireless device 104) may be amplified by the LNA 230, and the mixer 232 mixes the amplified RF signals with a receive local oscillator (LO) signal to convert the RF signal to a baseband frequency (e.g., downconvert). The baseband signals output by the mixer 232 may be filtered by the BBF 234 before being converted by an analog-to-digital converter (ADC) 236 to digital I or Q signals for digital signal processing. The modem 212 may receive the digital I or Q signals and further process the digital signals, for example, demodulating the digital signals.

Certain transceivers may employ frequency synthesizers with a voltage-controlled oscillator (VCO) to generate a stable, tunable LO frequency with a particular tuning range. Thus, the transmit LO frequency may be produced by a frequency synthesizer 238, which may be buffered or amplified by an amplifier (not shown) before being mixed with the baseband signals in the mixer 226. Similarly, the receive LO frequency may be produced by the frequency synthesizer 238, which may be buffered or amplified by an amplifier (not shown) before being mixed with the RF signals in the mixer 232. Separate frequency synthesizers may be used for the TX path 214 and the RX path 216.

While in a reception mode, the modem 212 may obtain digitally converted signals via the ADC 236 and RX path 216. As an example, in the modem 212, digital signals may be provided to the DSP circuitry, which is configured to acquire a received signal, for example, by detecting the presence of the signal and estimating the initial timing and frequency offsets. The DSP circuitry is further configured to digitally condition the digital signals, for example, using channel (narrowband) filtering, analog impairment conditioning (such as correcting for I/Q imbalance), and applying digital gain to ultimately obtain a narrowband signal. The output of the DSP circuitry may be fed to the AGC, which is configured to use information extracted from the digital signals, for example, in one or more received training fields, to determine an appropriate gain. The output of the DSP circuitry also may be coupled with the demodulator, which is configured to extract modulated symbols from the signal and, for example, compute the logarithm likelihood ratios (LLRs) for each bit position of each subcarrier in each spatial stream. The demodulator may be coupled with the decoder, which may be configured to process the LLRs to provide decoded bits. The decoded bits from all of the spatial streams may be fed to the demultiplexer for demultiplexing. The demultiplexed bits may be descrambled and provided to a medium access control layer (e.g., the processor 210) for processing, evaluation, or interpretation.

The processor 210 and/or modem 212 may control the transmission of signals via the TX path 214 and/or reception of signals via the RX path 216. In some aspects, the processor 210 and/or modem 212 may be configured to perform various operations, such as those associated with any of the methods described herein. The processor 210 and/or the modem 212 may include a microcontroller, a microprocessor, an application processor, a baseband processor, a MAC processor, an artificial intelligence (AI) processor, a digital signal processor (DSP), an application specific integrated circuit (ASIC), a field programmable gate array (FPGA) or other programmable logic device (PLD), discrete gate or transistor logic, discrete hardware components, or any combination thereof. In some cases, aspects of the processor 210 may be integrated with (incorporated in and/or shared with) the modem 212, such as the RF exposure manager 106, a microcontroller, a microprocessor, a baseband processor, a medium access control (MAC) processor, a digital signal processor, etc. For example, the processor 210 may be representative of one or more co-processors (e.g., one or more microprocessors) associated with the modem 212, and the modem 212 may be representative of one or more ASICs including the baseband processor, MAC processor, DSP, and/or neural network processor. The memory 240 may store data and program codes (e.g., computer-readable instructions) for performing wireless communications as described herein. The memory 240 may be external to the processor 210 and/or the modem 212 (as illustrated) and/or incorporated therein. In certain cases, the RF exposure manager 106 (as implemented via the processor 210 and/or modem 212) may determine a transmit power (e.g., corresponding to certain levels of gain(s) applied to the TX path 214 including the BBF 224, the mixer 226, and/or the PA 228) that complies with an RF exposure limit set by country-specific regulations and/or international guidelines (e.g., International Commission on Non-Ionizing Radiation Protection (ICNIRP) guidelines) as described herein.

In certain aspects, the first wireless device 102 may include sensing circuitry 260 used to identify an exposure scenario (such as head exposure, extremity (e.g., hand) exposure, body (body-worn) exposure, hotspot exposure, etc.) associated with the first wireless device 102. The sensing circuitry 260 may collect measurements which are indicative of the exposure scenario, and the processor 210 may access the measurements from the sensing circuitry 260 to determine the exposure scenario. For example, the sensing circuitry 260 may include an on-off body sensor 262 and/or a proximity sensor 264. The on-off body sensor 262 may indicate or detect whether the first wireless device 102 is positioned on or off the body of a human (e.g., the human 108). The on-off body sensor 262 may be or include a capacitive touch sensor (e.g., a touch display or fingerprint reader), an optical sensor (e.g., a photoelectric sensor and/or camera), an inertial measurement unit (IMU), accelerometer, etc.

The proximity sensory 264 may indicate or detect whether the first wireless device 102 is proximate to human tissue with respect to a specified separation distance for RF exposure compliance. The proximity sensor 264 may be or include a radar sensor, a sonic sensor (e.g., an ultrasonic sensor), an optical sensor (e.g., a photoelectric sensor), etc. In some cases, the proximity sensor 264 may be implemented in part via the radio 250. For example, the radio 250 may be used as a radar sensor to detect the proximity of human tissue. In certain cases, a response associated with a transmission (e.g., impedance, power, efficiency, voltage standing wave ratio, etc.) may be indicative of whether human tissue is proximate to the first wireless device 102.

FIG. 2 shows an example transceiver design. It will be appreciated that other transceiver designs or architectures may be applied in connection with aspects of the present disclosure. For example, while examples discussed herein utilize I and Q signals (e.g., quadrature modulation), those of skill in the art will understand that components of the transceiver may be configured to utilize any other suitable modulation, such as polar modulation. As another example, circuit blocks may be arranged differently from the configuration shown in FIG. 2, and/or other circuit blocks not shown in FIG. 2 may be implemented in addition to or instead of the blocks depicted.

### Aspects of RF Exposure Compliance

In certain cases, compliance with an RF exposure limit may be performed as a time-averaged RF exposure evaluation within a specified running (moving) time window associated with the RF exposure limit. The RF exposure limit may specify a time-averaged RF exposure metric (e.g., SAR and/or PD) over the running time window. As an example, the Federal Communications Commission (FCC) specifies that certain SAR limits (general public exposure) are 0.08 W/kg, as averaged over the whole body, and a peak spatial-average SAR of 1.6 W/kg, averaged over any 1 gram of tissue (defined as a tissue volume in the shape of a cube) for sub-6 GHz bands, whereas certain PD limits are 1 mW/cm², as averaged over the whole body, and a peak spatial-average PD of 4 mW/cm², averaged over any 1 cm². The FCC also specifies the corresponding averaging time may be six minutes (360 seconds) for sub-6 GHz bands, whereas the averaging time may be 2 seconds for mmWave bands (e.g., 60 GHz frequency bands) under a proposed regulation, for example. Under the proposed regulation, the FCC specifies time windows for various frequency ranges according to the following table:

TABLE 1

| | Frequency (GHz) | | | | |
|---|---|---|---|---|---|
| | <2.9 | 2.9-7.125 | 7.125-10.5 | 10.5-15.4 | 15.4-24 |
| Avg. Time | 100 | 49 | 27 | 14 | 7 |
| (seconds) | | | | | |

Frequency (GHz)

| | 24-37 | 37-53 | 53-95 | >95 |
|---|---|---|---|---|
| Avg. Time | 4 | 3 | 2 | 1 |
| (seconds) | | | | |

The RF exposure limit and/or corresponding averaging time window may vary based on the frequency band. In certain aspects, the RF exposure limit(s) and/or corresponding averaging time window(s), if applicable, may be specific to a particular geographic region or country, such as the United States, Canada, China, or European Union. In some cases, the RF exposure limit(s) may specify the maximum allowed RF exposure that can be encountered without time averaging. In such cases, the maximum allowed RF exposure may correspond to a maximum output or transmit power that can be used by the wireless device.

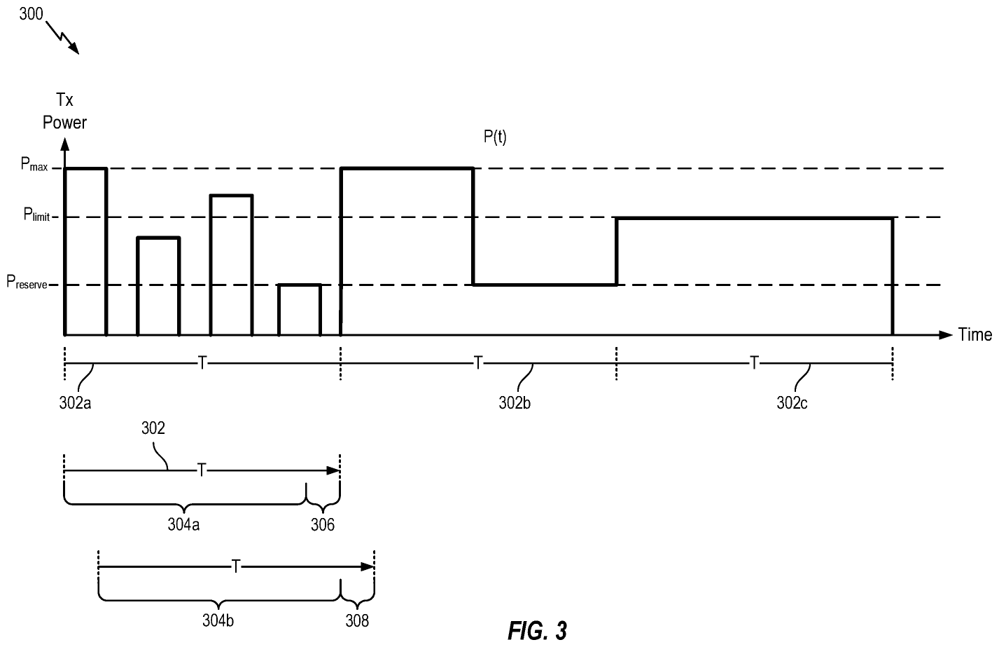

FIG. 3 is a graph 300 of a transmit power over time (P (t)) that varies over a running (e.g., rolling or moving) time window (T) associated with the RF exposure limit. The wireless device (e.g., the first wireless device 102) may evaluate RF exposure compliance over the running time window 302 (T) based on past RF exposure (e.g., a transmit power report) in a past time interval 304a of the time window 302 and a future time interval 306. The wireless device may determine the maximum allowed transmit power for the future time interval 306 that satisfies the time-averaged RF exposure limit based on the past RF exposure used in the past time interval 304a. The wireless device may perform such a time-averaging evaluation as the time window 302 moves over time, for example, in the next future time interval 308, where the past time interval 304b now includes the previous future time interval 306.

The maximum time-averaged transmit power limit (Pₗᵢₘᵢₜ) represents the maximum transmit power the wireless device can transmit continuously for the duration of the running time window 302 (T) in compliance with the RF exposure limit. For example, the wireless device is transmitting continuously at Pₗᵢₘᵢₜ in the third time window 302c such that the time-averaged transmit power over the time window (e.g., the third time window 302c) is equal to Pₗᵢₘᵢₜ in compliance with the time-averaged RF exposure limit.

In certain cases, an instantaneous transmit power may exceed Pₗᵢₘᵢₜ in certain transmission occasions, for example, as shown in the first time window 302a and the second time window 302b. In some cases, the wireless device may transmit at Pₘₐₓ, which may be the maximum instantaneous transmit power supported by the wireless device, the maximum instantaneous transmit power the wireless device is capable of outputting, or the maximum instantaneous transmit power allowed by a standard or regulatory body (e.g., the maximum output power, P_{CMAX}). In some cases, the wireless device may transmit at a transmit power less than or equal to Pₗᵢₘᵢₜ in certain transmission occasions, for example, as shown in the first time window 302a.

In certain cases, a reserve power may be used to enable a continuous transmission within a time window (T) when transmitting above Pₗᵢₘᵢₜ in the time window or to enable a certain level of quality for certain transmissions. As shown in the second time window 302b, the transmit power may be backed off from Pₘₐₓ to a reserve power (Pᵣₑₛₑᵣᵥₑ) so that the wireless device can maintain a continuous transmission during the time window (e.g., maintain a radio connection with a receiving entity) in compliance with the time-averaged RF exposure limit. In the third time window 302c, the wireless device may increase the transmit power to Pₗᵢₘᵢₜ in compliance with the time-averaged RF exposure limit. In some cases, Pᵣₑₛₑᵣᵥₑ may allow for a certain level of transmission quality for certain transmissions (e.g., control signaling, high priority communications, low latency communications, highly reliable communications, etc.). Pᵣₑₛₑᵣᵥₑ may be used to reserve transmit power for at least a portion of the time window 302 for certain transmissions (e.g., control signaling).

In the second time window 302b, the area between Pₘₐₓ and Pᵣₑₛₑᵣᵥₑ for the time duration of transmitting at Pₘₐₓ may be equal to the area between Pₗᵢₘᵢₜ and Pᵣₑₛₑᵣᵥₑ for the time window T, such that the total area of transmit power (P(t)) in the second time window 302b is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit.

In some aspects, the wireless device may transmit at a power that is higher than Pₗᵢₘᵢₜ, but less than Pₘₐₓ in the time-average mode illustrated in the second time window 302b. While a single transmit burst is illustrated in the second time window 302b, it will be understood that the wireless device may instead utilize a plurality of transmit bursts within the time window (T), where the transmit bursts are separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above Pₗᵢₘᵢₜ.

In certain aspects, the wireless device may transmit at a power less than or equal to a fixed power limit (e.g., Pₗᵢₘᵢₜ) without considering past exposure and/or past transmit powers in terms of a time-averaged RF exposure. For example, the wireless device may transmit at a power less than or equal to Pₗᵢₘᵢₜ using a look-up table (comprising one or more values of Pₗᵢₘᵢₜ depending on an RF exposure scenario). The look-up table may provide one or more values of Pₗᵢₘᵢₜ depending on the transmit frequency, transmit antenna, radio configuration (single-radio or multi-radio) and/or RF exposure scenario (e.g., a device state index corresponding to head exposure, body or torso exposure, extremity or hand exposure, and/or hotspot exposure) encountered by the wireless device. Examples of RF exposure scenarios include cases where the wireless device is emitting RF signals proximate to human tissue, such as a user's head, hand, or body (e.g., torso), or where the wireless device is being used as a hotspot away from human tissue. Therefore, the RF exposure can be managed as a time-averaged RF exposure evaluation (e.g., illustrated in FIG. 3), managed using a look-up table or flat or maximum value, or using another strategy or algorithm, where a particular process of managing the RF exposure may be referred to herein as an RF exposure control scheme.

For certain aspects, a wireless device may exhibit or be configured with a transmission duty cycle. The wireless device may determine transmit power level(s) and/or reserve power level(s) in compliance with the time-averaged RF exposure limit based on the duty cycle. The transmission duty cycle may be indicative of a share (e.g., 100 ms) of a specific period (e.g., 500 ms) in which the wireless device transmits RF signals. The duty cycle may be a ratio of the share to the specific period (e.g., 100 ms/500 ms), where the duty cycle may be represented as a number from zero to one. The duty cycle may be an effective duty cycle associated with a total transmit time of one or more transmissions in the time period, where the one or more transmissions may include bursts of transmissions having a gap of time positioned between at least two of the bursts. For example, in the first time window 302a, the duty cycle may be greater than 50% of the duration of the time window (T), whereas in the second time window 302b, the duty cycle may be equal to 100% of the duration of the time window (T). In certain cases, the duty cycle may be standardized (e.g., predetermined) with a specific RAT and/or vary over time, for example, due to changes in radio conditions, mobility, and/or user behavior.

As an example, certain RATs may specify the uplink duty cycle in the form of a time division duplexing (TDD) configuration, such as a TDD uplink-downlink (UL-DL) slot pattern in 5G NR or similar TDD patterns in E-UTRA or UMTS. In 5G NR, the TDD UL-DL slot pattern may specify the number of uplink slots and corresponding position in time associated with the uplink slots in a sequence of slots, such that the total number of uplink slots with respect to the total number of slots in the sequence is indicative of the duty cycle. In certain aspects, the duty cycle may correspond to the actual duration for past transmissions scheduled or used, for example, within the TDD UL-DL slot pattern. For example, although the wireless device may be configured with a TDD UL-DL slot pattern, the wireless device may use a portion or subset of the UL slots for transmitting RF signals. Thus, the duty cycle for the wireless device may be less than the maximum available duty cycle corresponding to the TDD UL-DL slot pattern.

### Example Reconfigurable Antennas for Eyewear

As discussed herein, eyewear may include a multi-mode antenna structure that enables selection of an antenna configuration for a given communications scenario. In certain aspects, the eyewear may select one or more antenna configurations for wireless communications depending on the traffic, channel conditions, carrier frequency, RF exposure history, RF exposure scenario, etc.

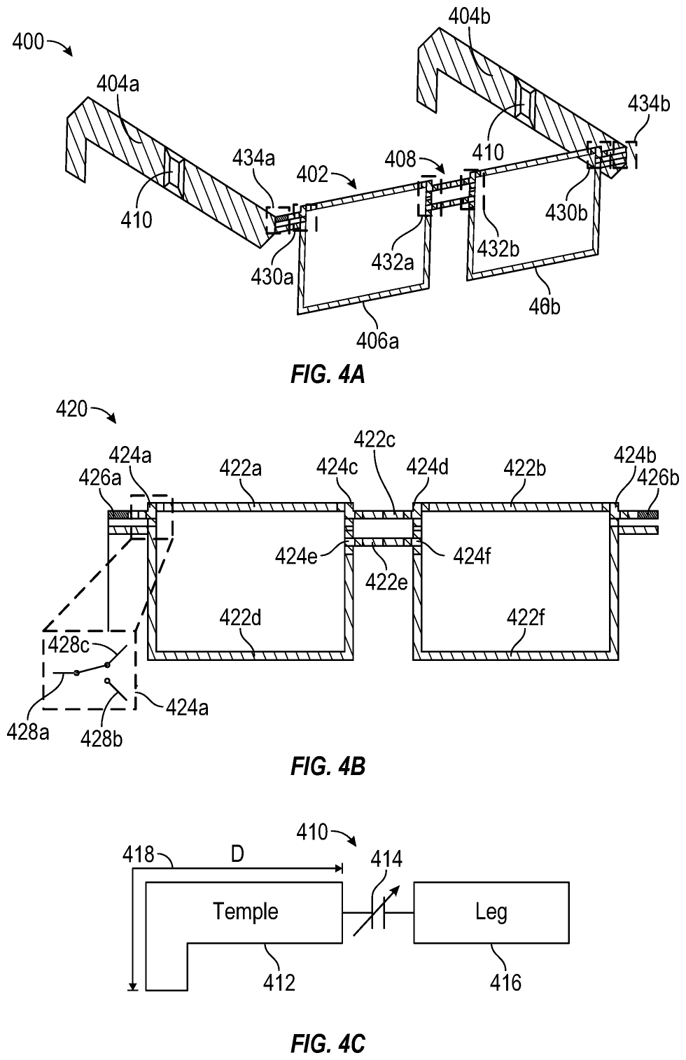

FIGS. 4A and 4B illustrate an example of eyewear 400 having a multi-mode antenna structure 420. Referring to FIG. 4A, the eyewear 400 comprises a frame 402 and one or more temple arms 404a, 404b (collectively arms 404) coupled to the frame 402. Each of the temple arms 404 may couple to the frame 402 via a hinge (not shown). The frame 402 includes a first rim 406a and a second rim 406b (collectively the rims 406). The frame 402 may include a bridge 408 coupled between the rims 406. In certain aspects, the eyewear 400 may include at least one antenna tuner 410 arranged at or on at least one of the temple arms 404. The antenna tuner 410 may include circuitry configured to match the impedance of a transmit path (e.g., the transmit path 214) to the impedance of an antenna (e.g., an antenna configuration of the multi-mode antenna structure 420) as further described herein with respect to FIG. 4C. Note that the design for the eyewear 400 depicted in FIG. 4 is an example, and the eyewear 400 may use another design in addition to or instead of that which is depicted. For example, the frame 402 may include a top bar (not shown) that couples to the rims 406. The top bar may be a feature found in a certain style of eyewear, such as aviator styles or other styles.

As shown in FIG. 4B, the multi-mode antenna structure 420 includes a plurality of antenna traces 422a-f (collectively the antenna traces 422), a set of switches 424a-f, and antenna feeds 426a, 426b.

Each of the antenna traces 422 may be or include an electrically conductive material, such as any of various metal alloys, metals, or conductive ceramics including aluminum (Al), chromium (Cr), cobalt (Co), copper (Cu), gold (Au), molybdenum (Mo), platinum (Pt), ruthenium (Ru), tantalum (Ta), titanium (Ti), tungsten (W), etc.

The set of switches 424a-f may be or include one or more electrical switches, such as one or more electrical relays, one or more transistors, one or more solid state switches, etc. In certain aspects, any one of the switches 424a-f may include one or more electrical switches. In some cases, any one of the switches 424a-f may include a single-pole double-throw (SPDT) switch as depicted with respect to the first switch 424a. For example, the first switch 424a may include a first terminal 428a, a second terminal 428b, and a third terminal 428c. The first terminal 428a may be coupled to the first antenna feed 426a; the second terminal 428b may be coupled to the fourth antenna trace 422d; and the third terminal 428c may be coupled to the first antenna trace 422a.

The first switch 424a may have multiple switching states where the first switch 424a is closed or open among the three terminals 428a-c. For example, in a first switching state, the first switch 424a is closed between the first terminal 428a and the third terminal 428c and open between the first terminal 428a and the second terminal 428b; in a second switching state, the first switch 424a is closed between the first terminal 428a and the second terminal 428b and open between the first terminal 428a and the third terminal 428c; and in a third switching state, the first switch 424a may be open between the first terminal 428a and the third terminal 428c and open between the first terminal 428a and the second terminal 428b. In yet another switching state (not shown), the first switch 424a may be closed between the first terminal 428a and the third terminal 428c and closed between the first terminal 428a and the second terminal 428b. Thus, the switching states of the first switch 424a may selectively couple the first antenna feed 426a to the fourth antenna trace 422d, selectively couple the first antenna feed 426a to the first antenna trace 422a, or selectively couple the first antenna feed 426a to the first antenna trace 422a and to the fourth antenna trace 422d. Each of the switches 424a-f may have the same (or different) switching states as described herein with respect to the first switch 424a.

Each switch of the set of switches 424a-f is coupled to at least one of the plurality of antenna traces 422. The set of switches 424a-f is configured to selectively switch among a plurality of switching states, such as the switching states described herein with respect to the first switch 424a. Each of the plurality of switching states are associated with a corresponding antenna configuration of a plurality of antenna configurations formed by the plurality of antenna traces 422, for example, as further described herein with respect to FIGS. 5A-E. In certain aspects, the set of switches 424a-f may be in communication with a processor or controller (e.g., the processor 210 and/or the modem 212) that is configured to output one or more control signals to switch the set of switches 424a-f into a combination of switching states and a corresponding antenna configuration. In certain aspects, the antenna configurations may form any of various types of antennas including, for example, a wire antenna, a monopole antenna, a dipole antenna, a butterfly antenna, a multipole antenna, a folded dipole antenna, a loop antenna, a halo antenna, a spiral antenna, a T-antenna, an inverted L-antenna, an inverted-F antenna (IFA), etc., or any combination thereof.

As an example combination of switching states, the first switch 424a may be closed between the first antenna feed 426a and the first antenna trace 422a; the third switch 424c may be closed between the first antenna trace 422a and the third antenna trace 422c; and the fourth switch 424d may be closed between the third antenna trace 422c and the second antenna trace 422b. Such a combination of switching states among the first switch 424a, the third switch 424c, and the 424d may form an antenna configuration, which includes the first antenna feed 426 being coupled to the first antenna trace 422a and the third antenna trace 422c being coupled to between the first antenna trace 422c and the second antenna trace 422b as further described herein with respect to FIG. 5A. Some example antenna configurations are further described herein with respect to FIGS. 5A-E.

In this example, the first antenna feed 426a is selectively coupled to the first antenna trace 422a and the fourth antenna trace 422d via the first switch 424a. The second antenna feed 426b is selectively coupled to the second antenna trace 422b and the sixth antenna trace 422f via the second switch 424b. The first switch 424a is coupled to the first antenna feed 426a, the first antenna trace 422a, and the fourth antenna trace 422d. The second switch 424b is coupled to the second antenna feed 426b, the second antenna trace 422b, and the sixth antenna trace 422f. The third switch 424c is coupled to at least the first antenna trace 422a, the third antenna trace 422c, and the fifth switch 424e. The fourth switch 424d is coupled to at least the second antenna trace 422b, the third antenna trace 422c, and the sixth switch 424f. The fifth switch 424e is coupled to the fourth antenna trace 422d, the third switch 424c, and the fifth antenna trace 422e. Finally, the sixth switch 424f is coupled to the fourth switch 424d, the fifth antenna trace 422e, and the sixth antenna trace 422f.

The first rim 406a of the frame 402 includes at least one switch of the plurality of switches (e.g., the first switch 424a, the third switch 424c, and the fifth switch 424e) and at least one antenna trace of the plurality of antenna traces (e.g., the first antenna trace 422a and the fourth antenna trace 422d). The second rim 406b of the frame 402 includes one or more switches of the plurality of switches (e.g., the second switch 424b, the fourth switch 424d, and the sixth switch 424f) and one or more antenna traces of the plurality of antenna traces (e.g., the second antenna trace 422b and the sixth antenna trace 422f).

In certain aspects, the antenna traces 422a-f, the set of switches 424a-f, and the antenna feeds 426a, 426b are arranged in particular locations of the frame 402. For example, as the frame 402 may be designed to hold lenses (not shown) or have openings for lenses, components of the multi-mode antenna structure 420 may be arranged at, on, or along parts of the frame 402 that follow the shape of the lenses. As shown in FIGS. 4A and 4B, the first switch 424a is arranged at a hinge location 430a of the first rim 406a. The second switch 424b is arranged at a hinge location 430b of the second rim 406b. The third switch 424c is arranged at a first bridge location 432a of the first rim 406a. The fourth switch 424d is arranged at a second bridge location 432b of the second rim 406b. The fifth switch 424e is arranged at the first bridge location 432a of the first rim 406a. Finally, the sixth switch 424f is arranged at the second bridge location 432b of the second rim 406b. The first antenna trace 422a and the fourth antenna trace 422d are arranged along the first rim 406a. The third antenna trace 422c and the fifth antenna trace 422e are arranged between the first rim 406a and the second rim 406b. The second antenna trace 422b and the sixth antenna trace 422f are arranged along the second rim 406b. The first antenna feed 426a is arranged at a first temple location 434a of the frame 402. The second antenna feed 426b is arranged at a second template location 434b of the frame.

Note that the multi-mode antenna structure 420 is an example antenna design for eyewear capable of wireless communications. Other multi-mode antenna structures may be used in addition to or instead of the multi-mode antenna structure 420 described herein. In some cases, the antenna traces 422 may be arranged in accordance with the shape of the lenses and/or frame of the eyewear. For example, the lenses may have a circular, oval, or semi-circular shape, and the antenna traces 422 may be arranged to fit the shape of the lenses. In some cases, the multi-mode antenna structure 420 may have any number of antenna traces and/or switches to enable the formation of various antenna configurations as described herein with respect to FIGS. 5A-E. The antenna traces 422 are shown as being commensurate with the size and shape of the frame 402, but in other configurations the antenna traces 422 may cover only a portion of the frame 402.

FIG. 4C illustrates an example of the temple arm 404a having the antenna tuner 410. Note that the other temple arm 404b may include an antenna tuner 410 in addition to or instead of the temple arm 404a. In this example, the temple arm 404a includes a first arm portion 412, a second arm portion 416, and the antenna tuner 410 arranged between the first arm portion 412 and the second arm portion 416. The first arm portion 412 and the second arm portion 416 may be sections of a single arm or may be physically separated. The antenna tuner 410 is configured to adjust a resonant frequency associated with at least one of the antenna configurations of the plurality of antenna configurations. The antenna tuner 410 is coupled to the antenna traces 422, for example, via the antenna feed(s) 426a, 426b. In some cases, the antenna tuner 410 is configured to adjust the resonant frequency in at least one of a plurality of frequency bands, such as a low band (e.g., less than 1 GHz), mid band (e.g., 1 GHz-2 GHz), and/or a high band (e.g., 2 GHz-2.5 GHz) in 5G NR frequency ranges. In some cases, the low band, mid band, and high band ranges may be defined within a frequency range of less than 2.5, 6 or 7 GHz. The low band may be less than 1 GHz (e.g., 750-850 MHz), the mid band may be between 1 GHz and 2 GHz (e.g., ˜1.7 GHz), and the high band may be from 2 GHz to 2.5 GHz. In certain aspects, the antenna tuner may be configured to adjust the resonant frequency in only the low band (e.g., less than 1 GHz) of 5G NR frequency ranges.

The antenna tuner 410 includes at least one reactive electrical component, for example, an inductor and/or a capacitor. For example, the antenna tuner 410 may include an inductor (L) network antenna tuner comprising at least one inductor and at least one capacitor. As shown, the antenna tuner 410 includes a capacitive element 414 coupled between the first arm portion 412 and the second arm portion 416. In certain aspects, any of the first arm portion 412 and the second arm portion 416 may be or include an electrically conductive material, for example, as described herein with respect to the antenna traces 422. Any of the first arm portion 412 and the second arm portion 416 may have electrical properties, such as, a resistance, capacitive reactance, and/or inductive reactance.

The capacitive element 414 may be or include, for example, a tantalum capacitor, aluminum capacitor, ceramic capacitor, a varactor, a metal-insulator-metal (MIM) capacitor, metal-oxide-metal (MOM) capacitor, a metal-oxide-semiconductor (MOS) capacitor, a metal fringe capacitor, a trench capacitor, a junction capacitance of a diode or transistor, or the like. The capacitive element 414 may have a variable capacitance to enable tuning of the resonant frequency as described herein. In some cases, the position of the capacitive element 414 may be selected to adjust or refine the impedance matching between the transmit path and the multi-mode antenna structure 420. For example, a distance (D) 418 may define a displacement from an end of the temple arm 404 to a terminal of the capacitive element 414. As the positioning of the capacitive element 414 may affect the impedance of the antenna tuner 410, D may be selected to enable tuning of the resonant frequency within a particular frequency bandwidth of a frequency band (e.g., the low band).

In certain aspects, the multi-mode antenna structure may have multiple antenna configurations as discussed above. For example, a first switching state of the plurality of switching states may be associated with a first antenna configuration of the plurality of antenna configurations, where the first antenna configuration forms a single antenna. In certain aspects, the first antenna configuration is configured to operate in a single input single output (SISO) wireless communication mode. In some cases, the multi-mode antenna structure may form multiple antennas, for example, for multiple input multiple output (MIMO) wireless communications. A second switching state of the plurality of switching states may be associated with a second antenna configuration of the plurality of antenna configurations, where the second antenna configuration forms multiple antennas. In certain aspects, the second antenna configuration is configured to operate in a MIMO wireless communication mode.

FIGS. 5A-C illustrate example antenna configurations that form a single antenna, for example, for SISO communication mode. As shown in FIG. 5A, a first antenna configuration 500a forms a first antenna 502 from a series connection among the first antenna trace 422a, the third antenna trace 422c, and the second antenna trace 422b. In some cases, the first antenna 502 may effectively be a monopole antenna.

In these examples, the respective switches coupled between the antenna traces that form the antenna may be in a closed state to allow the respective series connection(s) described herein. For example, for the first antenna configuration 500a, the first switch 424a is closed between the terminals that couple the first antenna feed 426a to the first antenna trace 422a, the third switch 424c is closed between the terminals that couple the first antenna trace 422a to the third antenna trace 422c, and the fourth switch 424d is closed between the terminals that couple the third antenna trace 422c to the second antenna trace 422b.

Note that the first antenna 502 may be electrically excited from the first antenna feed 426a or the second antenna feed 426b, for example, depending on the communications scenario. For example, the eyewear may select to switch between exciting the first antenna 502 between the first antenna feed 426a and the second antenna feed 426b to distribute the RF exposure across the user's face, for example, from one side of the face to another. In some cases, the eyewear may select to switch between exciting the first antenna 502 between the first antenna feed 426a and the second antenna feed 426b to change the directivity of the radiation pattern

Referring to FIG. 5B, a second antenna configuration 500b forms a second antenna 504 from a series connection among the first antenna trace 422a and the fourth antenna trace 422d. In some cases, the second antenna 504 may effectively be a loop antenna or a folded dipole antenna. Note that a similar antenna configuration may form a fourth antenna 508 from a series connection among the second antenna trace 422b and the sixth antenna trace 422f, for example, as depicted in FIG. 5D. In some cases, the eyewear may select the antenna configuration used for one or more transmissions to distribute the RF exposure across parts of a user's face, for example, switching between the second antenna 504 and the fourth antenna 508, as further described herein with respect to FIGS. 6A and 6B.

As depicted in FIG. 5C, a third antenna configuration 500c forms a third antenna 506 from a series connection among the first antenna trace 422a, the third antenna trace 422c, the second antenna trace 422b, the sixth antenna trace 422f, the fifth antenna trace 422e, and the fourth antenna trace 422d. In some cases, the third antenna 506 may effectively be a loop antenna or a folded dipole antenna.

FIGS. 5D and 5E illustrate example antenna configurations used for MIMO communications. Referring to FIG. 5D, a fourth antenna configuration 500d form the second antenna 504 and fourth antenna 508, for example, as described herein with respect to FIG. 5B. In some cases, the two antennas 504, 508 may operate in a MIMO communications mode. As shown in FIG. 5E, a fifth antenna configuration 500e forms a fifth antenna 510 from all of the antenna traces 422 being coupled together for a MIMO communications mode. For MIMO communications, the eyewear may communicate using the fifth antenna 510 in a receive mode and a transmit mode.

In certain aspects, the eyewear may adapt the antenna configuration of the multi-mode antenna structure in response to one or more RF exposure scenarios and/or the RF exposure history exhibited by the eyewear, for example, as described herein with respect to FIG. 3. The various antenna configurations provided by the multi-mode antenna structure may correspond to a specific RF exposure exhibited by the antenna used for a transmission. Depending on the communications scenario (e.g., the antenna configuration, transmit power, carrier frequency, and/or RF exposure scenario), the eyewear may exhibit different antenna efficiencies and/or RF exposures.

For example, when the eyewear is held in the user's hand transmitting in SISO mode at a carrier frequency in a low band (e.g., less than 1 GHz) with the first antenna configuration 500a, the eyewear may exhibit a low RF exposure (e.g., a peak SAR of 0.377 W/kg) and an antenna efficiency of about 61%. As another example, when the eyewear is worn on the user's face transmitting in a MIMO mode at a carrier frequency in the high band (e.g., ˜2.5 GHz) with the fourth antenna configuration 500d, the eyewear may exhibit a higher RF exposure (e.g., a peak SAR of 1.246 W/kg) and a lower antenna efficiency (e.g., 44%). When the eyewear is in a free-space (FS) exposure scenario, the eyewear may exhibit high antenna efficiencies, for example, greater than 89% for low band, mid band, and high band carrier frequencies. The free-space exposure scenario may be or include when a wireless communication device is not positioned proximate to human tissue (e.g., when there is a separation distance greater than 25 mm between the antenna and human tissue) with respect to an RF exposure specification.

As discussed herein with respect to FIG. 3, a wireless communication device may evaluate the past RF exposure to determine a permissible transmit power (e.g., a maximum allowed transmit power) for future transmission(s). As the transmit power is proportional to the RF exposure, the eyewear 400 may track the RF exposure exhibited by the eyewear 400, for example, in the form of one or more transmit powers used for one or more transmission(s). In some cases, an RF exposure specification may provide a time-averaged RF exposure limit, for example, an MPE that is allowed over a certain time window (e.g., T) in FIG. 3. In such cases, the eyewear 400 may track the time-averaged RF exposure in the form of a time-averaged transmit power over a time-averaging time window (e.g., T). For example, an RF exposure report may include a time-averaged transmit power over the time window and/or a set of transmit powers used over the time window in respective time interval(s) (e.g., the past time interval 304 and/or the future time interval 306).

The eyewear may select the antenna configuration used for transmissions depending on the communications scenario and the past RF exposure. For example, when there is budget for high RF exposure (e.g., at Pₘₐₓ), the eyewear may select an antenna configuration for MIMO communications. When to comply with the RF exposure specification the eyewear is transmitting at a transmit power at or below Pₗᵢₘᵢₜ, the eyewear may select an antenna configuration that exhibits a lower RF exposure, such as the first antenna configuration 500a.

In some cases, the RF exposure specification may depend on the present exposure scenario of the wireless device. For example, for a head exposure scenario, the RF exposure specification may define the RF exposure limit as 1.6 W/kg, averaged over any 1 gram of tissue; whereas for extremity exposure (e.g., hand), the RF exposure specification may define the RF exposure limit as 4 W/kg, averaged over any 10 grams of tissue.

FIG. 6A illustrates an example head exposure scenario 600A associated with the eyewear 400. In this example, the eyewear 400 is being worn on a user's head 602. As the eyewear 400 is emitting RF energy due to one or more RF transmissions, the eyewear 400 also exposes the user's head 602 to such RF energy. In certain aspects, the eyewear may select which antenna feed and/or antenna configuration to use for communications depending on the corresponding RF exposure. For example, to distribute the RF exposure across the user's face, the eyewear may switch among exciting the multi-mode antenna structure at the first antenna feed (in a SISO mode), at the second antenna feed (in a SISO mode), and/or at the first antenna feed and the second antenna feed (in a MIMO mode).

FIG. 6B illustrates an example hand exposure scenario 600B associated with the eyewear 400. In this example, the eyewear 400 is being held in a user's right hand 604. As the eyewear 400 is emitting RF energy due to one or more RF transmissions, the eyewear 400 also exposes the user's right hand 604 to such RF energy. In the hand exposure scenario 600B, the eyewear may expose the user's right hand 604 to less RF energy (e.g., less RF exposure) when exciting the multi-mode antenna structure from the second antenna feed compared to exciting the multi-mode antenna structure from the first antenna feed, and vice versa for a left hand exposure scenario. Therefore, with respect to the hand exposure scenario 600B depicted in FIG. 6B, the eyewear 400 may select to excite the multi-mode antenna structure from the second antenna feed to reduce the RF exposure exhibited by the transmission.

Note that the exposure scenarios 600A and 600B are merely examples, and the eyewear may be positioned in other exposure scenarios in addition to or instead of these examples.

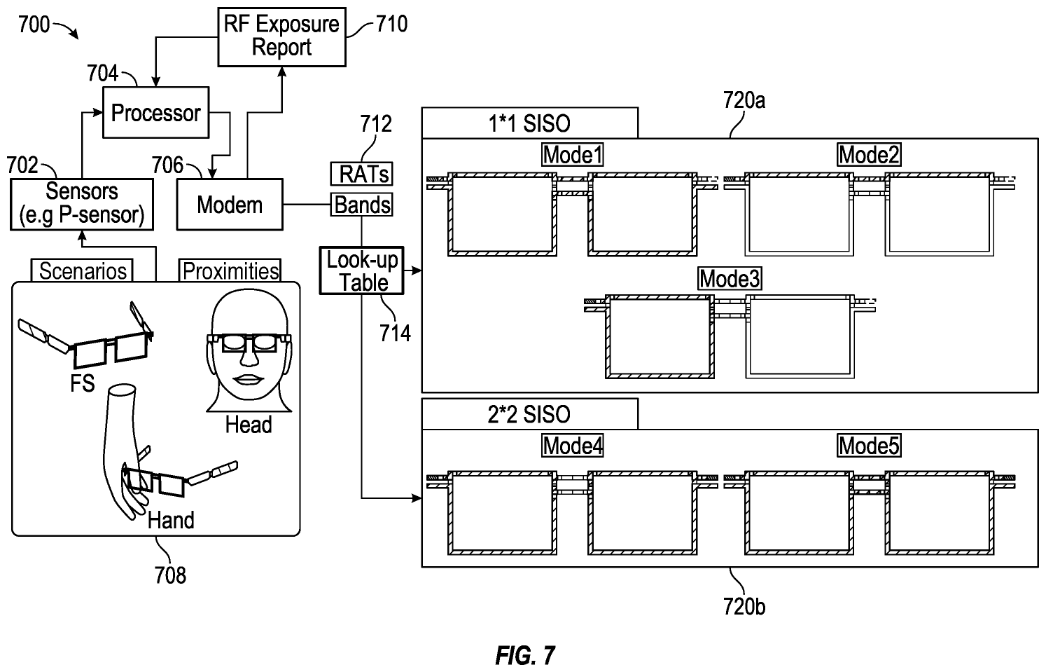

FIG. 7 illustrates an example architecture 700 for communicating via eyewear (e.g., the eyewear 400) with a multi-mode antenna structure (e.g., the multi-mode antenna structure 420). In this example, the architecture 700 includes one or more sensors 702 (e.g., the sensing circuitry 260), one or more processors 704 (e.g., the processor 210), and one or more modems 706 (e.g., the modem 212), for example, as described herein with respect to FIG. 2. In certain aspects, the sensor(s) 702, the processor(s) 704, and/or the modem(s) 706 may be arranged at or on the eyewear, for example, at or on one or temple arms of eyewear. In certain aspects, the sensor(s) 702, the processor(s) 704, and/or the modem(s) 706 may be arranged at or on a wireless communications device, such as a cellular phone, smart phone, or any other suitable portable computing device; and the wireless communications device may be in communication with the eyewear, for example, via a wired or wireless connection. In certain aspects, the sensor(s) 702, the processor(s) 704, and/or the modem(s) 706 may be distributed or shared among the eyewear and the wireless communications device, which is in communication with the eyewear. For example, a first processor and/or a first modem may be arranged at or on the eyewear, and a second processor and/or second modem may be arranged at or on the wireless communications device. Thus, any operations described herein with respect to communicating via eyewear may be distributed among the eyewear and the wireless communications device.

As discussed with respect to FIG. 2, the sensor(s) 702 may obtain one or more measurements, which are indicative of the present RF exposure scenario 708 of the eyewear. For example, the sensor(s) 702 may detect whether the eyewear is engaged in a head exposure scenario (e.g., as depicted in FIG. 6A), a body (e.g., body-worn) exposure scenario, an extremity exposure scenario (e.g., as depicted in FIG. 6B), a hotspot exposure scenario, an FS exposure scenario, etc. As discussed, the RF exposure scenario may define the applicable RF exposure limit (e.g., 1.6 W/kg for a head exposure scenario or 4 W/kg for an extremity exposure scenario) for transmissions.

The processor 704 may obtain one or more measurements from the sensor(s) 702 and determine the present RF exposure scenario based on the measurements. In certain aspects, the processor 704 may obtain, from the modem 706, an RF exposure report (as discussed herein) associated with one or more past transmission(s) of the eyewear. The RF exposure report may be indicative of the past RF exposure produced by the eyewear in a time-averaging time window (e.g., T of FIG. 3). The processor 704 may determine a maximum allowed transmit power that can be used in a time interval (e.g., the future time interval 306) based on the RF exposure report 710 and/or the exposure scenario 708. For example, the maximum allowed transmit power may be a transmit power that is in compliance with a time-averaged RF exposure limit associated with the exposure scenario and any past RF exposure produced by the eyewear as indicated by the RF exposure report 710. The time interval may be a portion of the time time-averaging time window (e.g., T of FIG. 3) associated with the RF exposure limit. For example, the time-averaging time window may be segmented into N number of time intervals for evaluating RF exposure compliance. As an example, the time interval may be 500 milliseconds.

The modem 706 may obtain the maximum allowed transmit power, which can be used in the time interval, from the processor 704. Based on a carrier frequency 712 (e.g., frequency bands of the RAT(s)) and the maximum allowed transmit power, the modem 706 may determine an antenna configuration among multiple antenna configurations 720a, 720b for one or more transmissions in the time interval. For example, the modem 706 may be configured with a table 714 that maps transmit powers to various communication scenarios, such as one or more combinations of an antenna configuration and carrier frequency (e.g., low band, mid band, and high band). The transmit powers in the table may be or include maximum allowed transmit powers, which are in compliance with an RF exposure limit, and/or adjusted maximum allowed transmit powers. For example, the adjusted maximum allowed transmit power may be a transmit power that satisfies an RF exposure limit as well as one or more other transmit power controls, such as interference controls (self-interference and/or external interference), RF emission controls (e.g., P_{CMAX}), power consumption controls, saturation controls, etc. The processor 704 and/or the modem 706 may be in communication with the set of switches of the eyewear, and the processor 704 and/or the modem 706 may output one or more control signals that switch the set of switches into a switching state (or a combination of switching states) for the antenna configuration as discussed above. The antenna configuration 720a, 720b may include the antenna configurations 500a-e as described herein with respect to FIGS. 5A-E.

In certain aspects, the modem 706 may select the antenna feed(s) to use for exciting the antenna associated with the selected antenna configuration in the time interval. For example, in a head exposure scenario, the modem 706 may switch between using the first antenna feed and the second antenna feed over the time interval to distribute the RF exposure across the face of the user. As another example, in a hand exposure scenario, the modem 706 may select the antenna feed having the greatest separation distance from human tissue to use for transmissions in the time interval. In certain aspects, the modem 706 may adjust the antenna tuner to improve the antenna efficiency at the carrier frequency, for example, as described herein with respect to FIG. 4C.

In some cases, the eyewear may transmit in the time interval at a transmit power that is less than the maximum allowed transmit power, for example, due to interference controls (self-interference and/or external interference), RF emission controls (e.g., P_{CMAX}), power consumption controls, saturation controls, etc. The modem 706 may send, to the processor, a new RF exposure report 710, which reflects the actual transmit power used in the time interval, to use for determining the maximum allowed transmit power in the next time interval (e.g., the time interval 308).

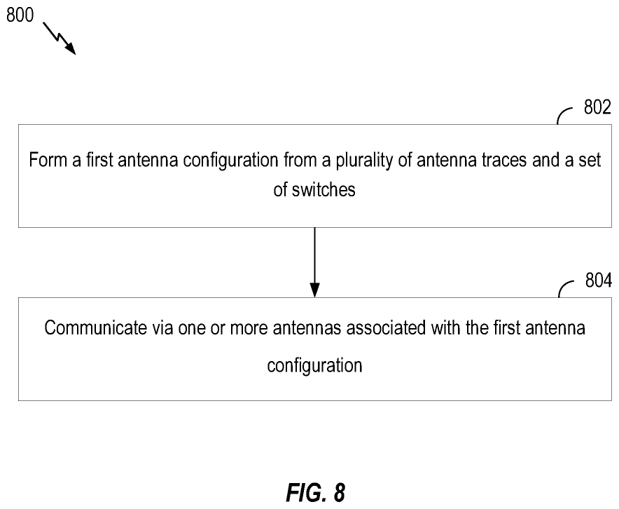

FIG. 8 is a flow diagram illustrating example operations 800 for wireless communication by a wireless device. The operations 800 may be performed, for example, by a wireless device (e.g., the first wireless device 102 in the wireless communication system 100) and/or eyewear (e.g., the eyewear 400). The operations 800 may be implemented as software components that are executed and run on one or more processors (e.g., the processor 210 and/or the modem 212 of FIG. 2). Further, the transmission and/or reception of signals by the wireless device in the operations 800 may be enabled, for example, by one or more antennas (e.g., antennas 218 of FIG. 2). In certain aspects, the transmission and/or reception of signals by the wireless device may be implemented via a bus interface of one or more processors (e.g., the processor 210 and/or the modem 212) obtaining and/or outputting signals for reception or transmission.

The operations 800 may optionally begin, at block 802, where the eyewear forms a first antenna configuration from a plurality of antenna traces and a set of switches, for example, as described herein with respect to FIG. 4. In certain aspects, the eyewear may have a frame comprising a multi-mode antenna structure, for example, as described herein with respect to FIG. 4. To form the first antenna configuration, the eyewear may switch the set of switches to a first switching state of the plurality of switching states, the first switching state being associated with a first antenna configuration of the plurality of antenna configurations, the first antenna configuration forming a single antenna of the one or more antennas.

At block 804, the eyewear communicates via one or more antennas associated with the first antenna configuration, for example, as described herein with respect to FIG. 7. For example, the eyewear may transmit a signal to another wireless communication device (e.g., any of the second wireless devices 104 depicted in FIG. 1). The signal may indicate (or carry) any of various information, such as data and/or control information.

In certain aspects, the eyewear may switch the set of switches to a second switching state of the plurality of switching states to form a second antenna configuration of the plurality of antenna configurations, the second antenna configuration forming multiple antennas of the one or more antennas.

In certain aspects, the eyewear obtains an RF exposure scenario (e.g., the exposure scenario 708) associated with a transmission of a signal. The eyewear switches the set of switches to a first switching state of a plurality of switching states based at least in part on the RF exposure scenario, the first switching state being associated with the first antenna configuration (e.g., a SISO mode or MIMO mode configuration). The eyewear outputs the signal for transmission using the first antenna configuration. The RF exposure scenario comprises one or more of: a head exposure scenario, an extremity (e.g., hand) exposure scenario, or a hotspot exposure scenario.

In certain aspects, the eyewear may determine the antenna configuration based on the past RF exposure, for example, as described herein with respect to FIG. 7. For example, the eyewear may select an antenna configuration that produces less RF exposure to satisfy the remaining RF exposure budget associated with an RF exposure specification (e.g., a time-averaged RF exposure limit). In some cases, the eyewear may select an antenna configuration that produces more RF exposure when the RF exposure budget allows for greater RF exposure in compliance with the RF exposure specification. For example, the eyewear may obtain one or more RF exposure reports (e.g., the RF exposure report 710) associated with one or more transmissions (e.g., past transmissions(s) in the time interval 304). To switch the set of switches to the first switching state, the eyewear may switch the set of switches to the first switching state further based at least in part on the one or more RF exposure reports.

In certain aspects, the eyewear may determine the antenna feed to use for the transmission based on the past RF exposure. In some cases, the eyewear may distribute the RF exposure across the user's face over time by switching among the available antenna feeds. In some cases, the eyewear may select the antenna feed that has the greatest separation distance from human tissue, for example, in a hand exposure scenario. To output the signal, the eyewear may output the signal via at least one of the first antenna feed or the second antenna feed based at least in part on the one or more RF exposure reports.

In certain aspects, the eyewear determine the carrier frequency based on the past RF exposure. For example, as the RF exposure may depend on the carrier frequency (e.g., less RF exposure may be produced at lower carrier frequencies), the eyewear may select the carrier frequency based at least in part on the available RF exposure budget associated with an RF exposure limit. The eyewear may output the signal in a frequency band selected based at least in part on the one or more RF exposure reports.

In certain aspects, the eyewear may adjust a resonant frequency associated with the first antenna configuration using an antenna tuner based at least in part on the one or more RF exposure reports, for example, as described herein with respect to FIG. 4C. The eyewear may include an antenna tuner coupled to the plurality of antenna traces, wherein the one or more processors are further configured to cause the eyewear to adjust a resonant frequency associated with the first antenna configuration using the antenna tuner based at least in part on the one or more RF exposure reports.

In certain aspects, the eyewear may determine the antenna configuration, the antenna feed to use for the transmission, the carrier frequency, and/or the resonant frequency based on a transmission state including, for example, the RF conditions (e.g., path loss or channel characteristics), the RF load impedance, transmission direction, etc. For example, the eyewear may determine to use a particular antenna configuration and/or antenna feed to transmit the signal from a particular direction (e.g., a left side of the user's head).

### Example Communications Device

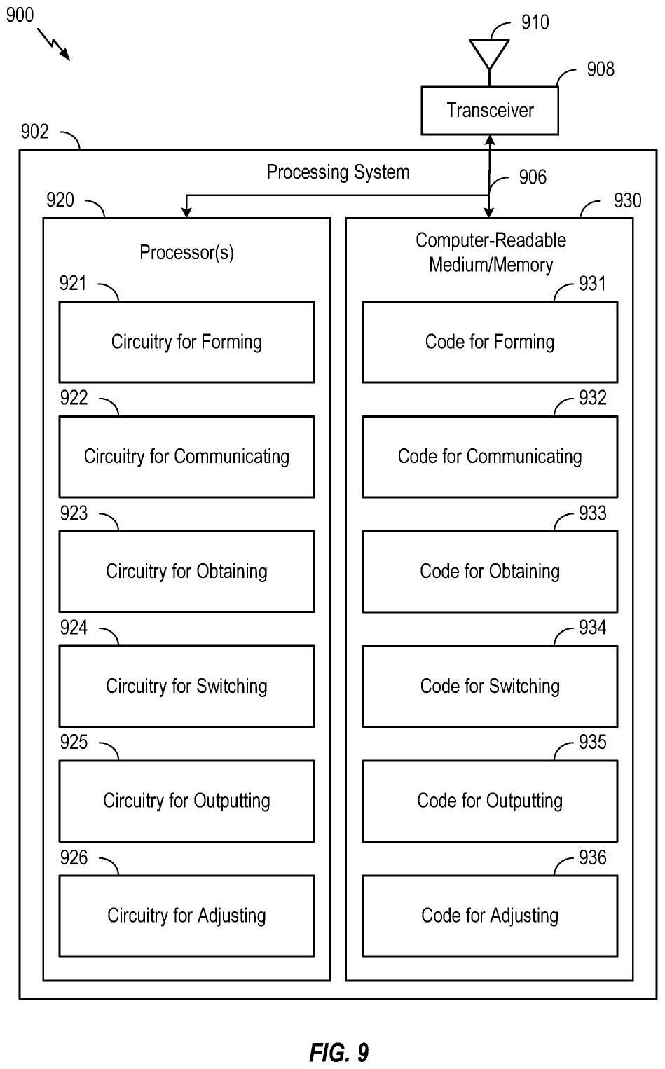

FIG. 9 depicts aspects of an example communications device 900. In some aspects, communications device 900 is a wireless communication device, such as the first wireless device 102 described above with respect to FIGS. 1 and 2 or the eyewear described above with respect to FIG. 4.

The communications device 900 includes a processing system 902 coupled to a transceiver 908 (e.g., a transmitter and/or a receiver). The transceiver 908 is configured to transmit and receive signals for the communications device 900 via an antenna 910, such as the various signals as described herein. The processing system 902 may be configured to perform processing functions for the communications device 900, including processing signals received and/or to be transmitted by the communications device 900.

The processing system 902 includes one or more processors 920. In various aspects, the one or more processors 920 may be representative of any of the processor 210 and/or the modem 212, as described with respect to FIG. 2. The one or more processors 920 are coupled to a computer-readable medium/memory 930 via a bus 906. In certain aspects, the computer-readable medium/memory 930 is configured to store instructions (e.g., computer-executable code) that when executed by the one or more processors 920, cause the one or more processors 920 to perform the operations 800 described with respect to FIG. 8, or any aspect related to the operations described herein. Note that reference to a processor performing a function of communications device 900 may include one or more processors performing that function of communications device 900. Reference to one or more processors performing multiple functions may include any one of the one or more processors performing any one of the multiple functions.

In the depicted example, computer-readable medium/memory 930 stores code (e.g., executable instructions) for forming 931, code for communicating 932, code for obtaining 933, code for switching 934, code for outputting 935, code for adjusting 936, or any combination thereof. Processing of the code 931-936 may cause the communications device 900 to perform the operations 800 described with respect to FIG. 8, or any aspect related to operations described herein.

The one or more processors 920 include circuitry configured to implement (e.g., execute) the code stored in the computer-readable medium/memory 930, including circuitry for forming 921, circuitry for communicating 922, circuitry for obtaining 923, circuitry for switching 924, circuitry for outputting 925, circuitry for adjusting 926, or any combination thereof. Processing with circuitry 921-926 may cause the communications device 900 to perform the operations 800 described with respect to FIG. 8, or any aspect related to operations described herein.

Various components of the communications device 900 may provide means for performing the operations 800 described with respect to FIG. 8, or any aspect related to operations described herein. For example, means for transmitting, sending or outputting for transmission may include the TX path 214 and/or antenna(s) 218 of the first wireless device 102 illustrated in FIG. 2 and/or transceiver 908 and antenna 910 of the communications device 900 in FIG. 9. Means for receiving or obtaining may include the RX path 216 and/or antenna(s) 218 of the first wireless device illustrated in FIG. 2 and/or transceiver 908 and antenna 910 of the communications device 900 in FIG. 9. Means for forming, switching, and/or adjusting may include one or more processors, such as the processor 210 and/or modem 212 depicted in FIG. 2 and/or the processor(s) 920 in FIG. 9.

### Example Aspects

Implementation examples are described in the following numbered clauses:

Aspect 1: Eyewear configured for wireless communications, comprising: a frame comprising a multi-mode antenna structure comprising: a plurality of antenna traces comprising a first antenna trace and a second antenna trace, a set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces; a first antenna feed selectively coupled to the first antenna trace via the first switch; and a second antenna feed selectively coupled to the second antenna trace via the second switch; and one or more temple arms coupled to the frame.

Aspect 2: The eyewear of Aspect 1, wherein: a first switching state of the plurality of switching states is associated with a first antenna configuration of the plurality of antenna configurations, the first antenna configuration forming a single antenna; and a second switching state of the plurality of switching states is associated with a second antenna configuration of the plurality of antenna configurations, the second antenna configuration forming multiple antennas.

Aspect 3: The eyewear of Aspect 2, wherein: the first antenna configuration is configured to operate in a single input single output (SISO) wireless communication mode; and the second antenna configuration is configured to operate in a multiple input multiple output (MIMO) wireless communication mode.

Aspect 4: The eyewear according to any of Aspects 1-3, wherein: the plurality of antenna traces further comprises a third antenna trace, a fourth antenna trace, a fifth antenna trace, and a sixth antenna trace; the first switch is further coupled to the first antenna trace and the fourth antenna trace; the second switch is further coupled to the second antenna trace and the sixth antenna trace; and the plurality of switches further comprises: a third switch coupled to at least the first antenna trace and the third antenna trace; a fourth switch coupled to at least the second antenna trace and the third antenna trace; a fifth switch coupled to the fourth antenna trace, the third switch, and the fifth antenna trace; and a sixth switch coupled to the fourth switch, the fifth antenna trace, and the sixth antenna trace.

Aspect 5: The eyewear of Aspect 4, wherein: a first rim of the frame includes at least one switch of the plurality of switches and at least one antenna trace of the plurality of antenna traces; and a second rim of the frame includes one or more switches of the plurality of switches and one or more antenna traces of the plurality of antenna traces.

Aspect 6: The eyewear of Aspect 5, wherein: the first switch is arranged at a hinge location of the first rim; the second switch is arranged at a hinge location of the second rim; the third switch is arranged at a first bridge location of the first rim; the fourth switch is arranged at a first bridge location of the second rim; the fifth switch is arranged at a second bridge location of the first rim; and the sixth switch is arranged at a second bridge location of the second rim.

Aspect 7: The eyewear of Aspect 5 or 6, wherein: the first antenna trace and the fourth antenna trace are arranged along the first rim; the third antenna trace and the fifth antenna trace are arranged between the first rim and the second rim; and the second antenna trace and the sixth antenna trace are arranged along the second rim.

Aspect 8: The eyewear according to any of Aspects 1-7, wherein: the first antenna feed is arranged at a first temple location of the frame, and the second antenna feed is arranged at a second template location of the frame.

Aspect 9: The eyewear according to any of Aspects 1-8, further comprising an antenna tuner coupled to the plurality of antenna traces, wherein the antenna tuner is configured to adjust a resonant frequency associated with at least one of the antenna configurations of the plurality of antenna configurations.

Aspect 10: The eyewear of Aspect 9, wherein the antenna tuner is configured to adjust the resonant frequency in at least one of a plurality of frequency bands.

Aspect 11: The eyewear of Aspect 9 or 10, wherein the antenna tuner comprises a reactive electrical component.

Aspect 12: The eyewear according to any of Aspects 1-11, further comprising: one or more memories; and one or more processors coupled to the one or more memories, the one or more processors being configured to cause the eyewear to: obtain a radio frequency (RF) exposure scenario associated with a transmission of a signal; switch the set of switches to a first switching state of the plurality of switching states based at least in part on the RF exposure scenario, the first switching state being associated with a first antenna configuration; and output the signal for transmission using the first antenna configuration.

Aspect 13: The eyewear of Aspect 12, wherein the RF exposure scenario comprises one or more of: a head exposure scenario, a hand exposure scenario, or a hotspot exposure scenario.

Aspect 14: The eyewear of Aspect 12 or 13, wherein: the one or more processors are further configured to cause the eyewear to obtain one or more RF exposure reports associated with one or more transmissions; and to switch the set of switches to the first switching state, the one or more processors are further configured to cause the eyewear to: switch the set of switches to the first switching state further based at least in part on the one or more RF exposure reports.

Aspect 15: The eyewear of Aspect 14, wherein to output the signal, the one or more processors are further configured to cause the eyewear to output the signal via at least one of the first antenna feed or the second antenna feed based at least in part on the one or more RF exposure reports.

Aspect 16: The eyewear of Aspect 14 or 15, wherein to output the signal, the one or more processors are further configured to cause the eyewear to output the signal in a frequency band selected based at least in part on the one or more RF exposure reports.

Aspect 17: The eyewear of Aspect 16, further comprising: an antenna tuner coupled to the plurality of antenna traces, wherein the one or more processors are further configured to cause the eyewear to adjust a resonant frequency associated with the first antenna configuration using the antenna tuner based at least in part on the one or more RF exposure reports.

Aspect 18: A method of wireless communications by eyewear, comprising: forming a first antenna configuration from a plurality of antenna traces and a set of switches, the plurality of antenna traces comprising a first antenna trace and a second antenna trace, the set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces; and communicating via one or more antennas associated with the first antenna configuration.

Aspect 19: The method of Aspect 18, further comprising: obtaining a radio frequency (RF) exposure scenario associated with a transmission of a signal; switching the set of switches to a first switching state of the plurality of switching states based at least in part on the RF exposure scenario, the first switching state being associated with the first antenna configuration; and wherein communicating via one or more antennas associated with the first antenna configuration comprises outputting the signal for transmission using the first antenna configuration.

Aspect 20: The method of Aspect 19, wherein the RF exposure scenario comprises one or more of: a head exposure scenario, a hand exposure scenario, or a hotspot exposure scenario.

Aspect 21: The method of Aspect 19 or 20, further comprising: obtaining one or more RF exposure reports associated with one or more transmissions; and wherein switching the set of switches to the first switching state comprises switching the set of switches to the first switching state further based at least in part on the one or more RF exposure reports.

Aspect 22: The method of Aspect 21, wherein outputting the signal comprises outputting the signal via at least one of a first antenna feed or a second antenna feed based at least in part on the one or more RF exposure reports, wherein the first antenna feed is selectively coupled to the first antenna trace via the first switch, and the second antenna feed is selectively coupled to the second antenna trace via the second switch.

Aspect 23: The method of Aspect 21 or 22, wherein outputting the signal comprises outputting the signal in a frequency band selected based at least in part on the one or more RF exposure reports.

Aspect 24: The method of Aspect 23, further comprising adjusting a resonant frequency associated with the first antenna configuration using an antenna tuner based at least in part on the one or more RF exposure reports, wherein the antenna tuner is coupled to the plurality of antenna traces.

Aspect 25: The method of Aspect 18, wherein forming the first antenna configuration comprises switching the set of switches to a first switching state of the plurality of switching states, the first switching state being associated with a first antenna configuration of the plurality of antenna configurations, the first antenna configuration forming a single antenna of the one or more antennas.

Aspect 26: The method of Aspect 25, further comprising: switching the set of switches to a second switching state of the plurality of switching states to form a second antenna configuration of the plurality of antenna configurations, the second antenna configuration forming multiple antennas of the one or more antennas.

Aspect 27: One or more apparatuses, comprising: one or more memories; and one or more processors configured to cause the one or more apparatuses to perform a method in accordance with any of Aspects 18-26.

Aspect 28: One or more apparatuses, comprising means for performing a method in accordance with any of Aspects 18-26.

Aspect 29: One or more non-transitory computer-readable media comprising executable instructions that, when executed by one or more processors of one or more apparatuses, cause the one or more apparatuses to perform a method in accordance with any of Aspects 18-26.

Aspect 30: One or more computer program products embodied on one or more computer-readable storage media comprising code for performing a method in accordance with any of Aspects 18-26.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a microcontroller, a microprocessor, a general-purpose processor, a digital signal processor (DSP), a neural network processor, an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a system on a chip (SoC), or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, identifying, mapping, applying, choosing, establishing, and the like.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an application specific integrated circuit (ASIC), or processor.

The following claims are not intended to be limited to the aspects shown herein, but are to be accorded the full scope consistent with the language of the claims. Within a claim, reference to an element in the singular is not intended to mean “one and only one” unless specifically so stated, but rather “one or more.” The use of a definite article (e.g., “the” or “said”) before an element is not intended to impart a singular meaning (e.g., “one and only one”) on an otherwise plural meaning (e.g., “one or more”) associated with the element unless specifically so stated. Unless specifically stated otherwise, the term “some” refers to one or more. No claim element is to be construed under the provisions of 35 U.S.C. § 112(f) unless the element is expressly recited using the phrase “means for.” All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims.

1. Eyewear configured for wireless communications, comprising:
a frame comprising a multi-mode antenna structure comprising:
a plurality of antenna traces comprising a first antenna trace and a second antenna trace,
a set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces;
a first antenna feed selectively coupled to the first antenna trace via the first switch; and
a second antenna feed selectively coupled to the second antenna trace via the second switch; and
one or more temple arms coupled to the frame.

2. The eyewear of claim 1, wherein:
a first switching state of the plurality of switching states is associated with a first antenna configuration of the plurality of antenna configurations, the first antenna configuration forming a single antenna; and
a second switching state of the plurality of switching states is associated with a second antenna configuration of the plurality of antenna configurations, the second antenna configuration forming multiple antennas.

3. The eyewear of claim 2, wherein:
the first antenna configuration is configured to operate in a single input single output (SISO) wireless communication mode; and
the second antenna configuration is configured to operate in a multiple input multiple output (MIMO) wireless communication mode.

4. The eyewear of claim 1, wherein:
the plurality of antenna traces further comprises a third antenna trace, a fourth antenna trace, a fifth antenna trace, and a sixth antenna trace;
the first switch is further coupled to the first antenna trace and the fourth antenna trace;
the second switch is further coupled to the second antenna trace and the sixth antenna trace; and
the plurality of switches further comprises:
a third switch coupled to at least the first antenna trace and the third antenna trace;
a fourth switch coupled to at least the second antenna trace and the third antenna trace;
a fifth switch coupled to the fourth antenna trace, the third switch, and the fifth antenna trace; and
a sixth switch coupled to the fourth switch, the fifth antenna trace, and the sixth antenna trace.

5. The eyewear of claim 4, wherein:
a first rim of the frame includes at least one switch of the plurality of switches and at least one antenna trace of the plurality of antenna traces; and
a second rim of the frame includes one or more switches of the plurality of switches and one or more antenna traces of the plurality of antenna traces.

6. The eyewear of claim 5, wherein:
the first switch is arranged at a hinge location of the first rim;
the second switch is arranged at a hinge location of the second rim;
the third switch is arranged at a first bridge location of the first rim;
the fourth switch is arranged at a first bridge location of the second rim;
the fifth switch is arranged at a second bridge location of the first rim; and
the sixth switch is arranged at a second bridge location of the second rim.

7. The eyewear of claim 5, wherein:
the first antenna trace and the fourth antenna trace are arranged along the first rim;
the third antenna trace and the fifth antenna trace are arranged between the first rim and the second rim; and
the second antenna trace and the sixth antenna trace are arranged along the second rim.

8. The eyewear of claim 1, wherein:
the first antenna feed is arranged at a first temple location of the frame, and
the second antenna feed is arranged at a second template location of the frame.

9. The eyewear of claim 1, further comprising an antenna tuner coupled to the plurality of antenna traces, wherein the antenna tuner is configured to adjust a resonant frequency associated with at least one of the antenna configurations of the plurality of antenna configurations.

10. The eyewear of claim 9, wherein the antenna tuner is configured to adjust the resonant frequency in at least one of a plurality of frequency bands.

11. The eyewear of claim 9, wherein the antenna tuner comprises a reactive electrical component.

12. The eyewear of claim 1, further comprising:
one or more memories; and
one or more processors coupled to the one or more memories, the one or more processors being configured to cause the eyewear to:
obtain a radio frequency (RF) exposure scenario associated with a transmission of a signal;
switch the set of switches to a first switching state of the plurality of switching states based at least in part on the RF exposure scenario, the first switching state being associated with a first antenna configuration; and
output the signal for transmission using the first antenna configuration.

13. The eyewear of claim 12, wherein:
the one or more processors are further configured to cause the eyewear to obtain one or more RF exposure reports associated with one or more transmissions; and
to switch the set of switches to the first switching state, the one or more processors are further configured to cause the eyewear to:
switch the set of switches to the first switching state further based at least in part on the one or more RF exposure reports.

14. The eyewear of claim 13, wherein to output the signal, the one or more processors are further configured to cause the eyewear to output the signal via at least one of the first antenna feed or the second antenna feed based at least in part on the one or more RF exposure reports.

15. The eyewear of claim 13, wherein to output the signal, the one or more processors are further configured to cause the eyewear to output the signal in a frequency band selected based at least in part on the one or more RF exposure reports.

16. The eyewear of claim 15, further comprising:
an antenna tuner coupled to the plurality of antenna traces, wherein the one or more processors are further configured to cause the eyewear to adjust a resonant frequency associated with the first antenna configuration using the antenna tuner based at least in part on the one or more RF exposure reports.

17. A method of wireless communications by eyewear, comprising:
forming a first antenna configuration from a plurality of antenna traces and a set of switches, the plurality of antenna traces comprising a first antenna trace and a second antenna trace, the set of switches comprising a first switch and a second switch, wherein each switch of the set of switches is coupled to at least one of the plurality of antenna traces, and wherein the set of switches is configured to selectively switch among a plurality of switching states, each of the plurality of switching states being associated with a corresponding antenna configuration of a plurality of antenna configurations formed by the plurality of antenna traces; and
communicating via one or more antennas associated with the first antenna configuration.

18. The method of claim 17, wherein forming the first antenna configuration comprises switching the set of switches to a first switching state of the plurality of switching states, the first switching state being associated with a first antenna configuration of the plurality of antenna configurations, the first antenna configuration forming a single antenna of the one or more antennas.

19. The method of claim 18, further comprising: switching the set of switches to a second switching state of the plurality of switching states to form a second antenna configuration of the plurality of antenna configurations, the second antenna configuration forming multiple antennas of the one or more antennas.

20. The method of claim 17, further comprising:
obtaining a radio frequency (RF) exposure scenario associated with a transmission of a signal;
switching the set of switches to a first switching state of the plurality of switching states based at least in part on the RF exposure scenario, the first switching state being associated with the first antenna configuration; and
wherein communicating via one or more antennas associated with the first antenna configuration comprises outputting the signal for transmission using the first antenna configuration.
